(19) United States
(12) Patent Application Publication
(10) Pub. No.: US 2009/0301902 A1
(43) Pub. Date: Dec. 10, 2009

(54) PROCESS FOR PRODUCING NANOPOROUS CARBIDE-DERIVED CARBON WITH INCREASED GAS STORAGE CAPABILITY

(76) Inventors: Yury Gogotsi, Ivyland, PA (US); Gleb Yushin, Philadelphia, PA (US); Ranjan Kumar Dash, Philadelphia, PA (US); John E. Fisher, Swarthmore, PA (US)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 11/915,953

(22) PCT Filed: Jun. 1, 2006
(86) PCT No.: PCT/US06/21140

§ 371 Date: Jan. 30, 2008

Related U.S. Application Data
(60) Provisional application No. 60/686,278, filed on Jun. 1, 2005.

(51) Int. Cl. F17C 11/00; C01B 31/02

(52) U.S. Cl. 206/7; 423/445 R

(57) ABSTRACT

Methods for producing and using nanoporous carbide-derived carbon in applications involving gas storage are provided.

This patent application claims the benefit of priority from U.S. Provisional Application Ser. No. 60/686,278, filed Jun. 1, 2005, teachings of which are herein incorporated by reference in their entirety.

### FIELD OF THE INVENTION

This invention relates to the methods for producing and using nanoporous carbide-derived carbon in applications involving gas storage. Nanoporous carbon for use in gas storage applications is produced by removal of metal from metal carbides at elevated temperatures in a halogen environment. For some gas storage applications, the nanoporous carbon is post treated in hydrogen to remove halogen and open the smallest pores and pore channels, thus increasing the sorption capacity of nanoporous carbide-derived carbon. The carbide-derived carbons produced by this method have a high surface area (up to 2000 m²/g), high pore volume (up to 1.2 cc/g) and precisely controllable pore size (0.5 to 10 nm).

### BACKGROUND OF THE INVENTION

The ability of a material to store a large amount of gas is a key requirement for many applications. For example, the use of hydrogen gas as a medium of transportation fuel is hindered by unavailability of materials able to store large amounts of hydrogen. The same is true for use of natural gas (methane) in vehicular applications.

The high energy per unit mass of hydrogen gas combined with the advantage of being pollution free and environmentally friendly makes hydrogen the fuel of choice for many applications. However, because hydrogen is the lightest gas, storing it effectively is very difficult. High hydrogen storage capacity is one of the key hurdles in the implementation of hydrogen as a source of fuel. The United States Department of Energy (DOE) has set a target of 6.5 wt % reversible hydrogen storage capacity by 2010.

Methane has the highest hydrogen to carbon ratio and has the highest energy per unit mass for any hydrocarbon. The costly affair and dangerous storage of compressed natural gas at extremely high pressure (200 bars) can be replaced by adsorbing natural gas on the surface of porous carbon at a lower pressure. Effective storage of methane is critical for its use as a fuel. The DOE has set a target of 180 v/v (volume of methane per volume of material) at 25° C. and up to 35 bar pressure.

Thus, there is a strong need for efficient gas storage materials for a variety of applications.

Gases like hydrogen and methane can be stored in many solid-state materials such as metal hydrides, metal organic framework and carbon materials. Carbon based nanomaterials are among the major candidates for gas storage due to their low molecular weight, wide variety of structures and carbon's abundance in nature. In particular, carbon nanotubes/nanofibers have been extensively studied to see if they are suitable for gas storage applications. However, poor gas storage capacity has been reported for these materials. The important parameters required to maximize high gas storage capacity in carbon materials are high surface area, narrowly distributed small pores, and high pore volume.

U.S. Pat. No. 6,579,833 discloses a process for converting a metal carbide to carbon by etching in halogens.

PCT/US2004/021382 discloses nanoporous carbide-derived carbon with tunable pore size.

This present invention is concerned with improvement of storage capacity of carbide-derived carbons.

### SUMMARY OF THE INVENTION

An object of the present invention is to provide methods for producing and using nanoporous carbon material with improved gas storage capacity.

Accordingly, an aspect of the present invention relates to a method for producing high, meaning greater than 300 m²/g surface area, porous carbon or carbon-containing material for storage and/or adsorption of gases via removal of a majority of non-carbon atoms from inorganic carbon-containing precursors.

Another aspect of the present invention relates to the use of these high surface area carbon-containing material in application(s) involving either storage or sorption of gases.

### BRIEF DESCRIPTION OF THE FIGURES

FIG. 1a through d provides line graphs depicting hydrogen sorption isotherms for nanoporous carbide-derived carbon (CDC) produced in accordance with the present invention. Hydrogen sorption isotherms for nanoporous CDCs produced from TiC, ZrC and SiC are depicted in FIG. 1a. FIGS. 1b, 1c and 1d show hydrogen sorption at various chlorination temperatures of nanoporous carbon produced from TiC, ZrC and B₄C, respectively. Solid squares indicate samples before hydrogen post treatment and hollow squares indicate samples after hydrogen post treatment. The measurements were performed at 1 atm pressure and 77K temperature.

FIG. 2 is a line graph depicting methane storage of nanoporous carbon produced by chlorination of SiC and B₄C at 1200° C. A storage capacity of 2.8 wt % (40.57 v/v) and 1.5 wt % (24.74 v/v) was recorded for CDC produced from SiC and B₄C, respectively, at a synthesis temperature of 1200° C. The measurements were performed at a temperature of 25° C.

FIG. 3 is a graph depicting room temperature high pressure hydrogen storage of CDC and activated carbon (AX21 called Amoco Carbon and obtained from Air Products). The CDC samples were produced by chlorination of TiC for 3 hours at 800° C. and subsequent treatment in H₂ at 600° C. for about 2 hours. The measurements were performed by VTI, Inc. (USA).

FIG. 4 is a graph showing the effect of ammonia treatment on H₂ storage. Graphs depicting hydrogen sorption isotherms for nanoporous carbide-derived carbon (CDC) produced by chlorination of TiC at 600° C. The measurements were performed at 77 K and up to 1 atmosphere pressure. At 1 atmosphere the as-produced CDC sample (stars) provide gravimetric hydrogen storage values (about 2.3 wt. %) inferior to the CDC samples that were subjected to high temperature (600C) treatment in ammonia for 30 minutes (square) or 60 minutes (circles) (about 2.6 wt. %). FIG. 5 is a graph depicting CO₂ adsorption (storage) on CDC at 0° C. and pressure up to ˜1 atmosphere. The CDC samples were produced by three hours chlorination from TiC at 400° C. (open inverted triangles) and TiC at 800° C. (open squares) and from ZrC at 300° C. (filled squares) and ZrC at 400° C. (asterisks). The ability of CDC to reversibly store CO₂ is useful for many applications. CO₂ emissions have been linked to global warming, and there has been a worldwide effort to reduce its emissions. CO₂ sequestration provides a means for long-term CO₂ storage. In addition to CO₂ storage for reducing emission, CDC can be used for effective removal of CO₂ from cabin atmospheres and portable life support systems.

FIG. 6 shows Energy Dispersive Spectroscopy (EDS) analyses of the chlorine content in CDC: weight % of chlorine in TiC and Ti₃SiC₂-CDC as a function of synthesis temperature. Ti₃SiC₂-CDC and TiC-CDC were analyzed 5-6 and 7-10 days after sample preparation, respectively. All the synthesized CDC were cooled under a chlorine purge after the high temperate synthesis (CDC synthesis was done by chlorination of either TiC or Ti₃SiC₂). Efficient chlorine trapping (over 40 wt %) was achieved at ambient pressure.

FIG. 7 is a graph depicting adsorption-of hydrogen on CDC at 77K. The CDC was derived from nanoparticles (about 30 nm in diameter) of SiC by chlorination at 900° C. for 3 hours. The measurements were performed by VTI, Inc. (USA)

### DETAILED DESCRIPTION OF THE INVENTION

The present invention provides a process for manufacturing of nanoporous carbon called carbide-derived carbon for applications in gas storage and sorption. This process of the present invention opens the small pores and pore channels in carbide-derived carbon and other carbon containing materials, thus increasing its sorption capacity by 40 to 70%. The carbon produced by this method has a high surface area, preferably greater than 300 m²/g and up to 2000 m²/g, high pore volume (up to 1.2 cc/g) and precisely controllable pore size (0.5-10 nm). Thus, carbide-derived carbon produced by this method is particularly useful for storage of hydrogen, carbon dioxide, methane and other gases. It can also be used for separation of a selective gas or gas mixture from other gases.

The material used in the present invention comprises nanoporous carbon produced by halogen treatment, preferably chlorination, of metal carbide, also referred to as carbide-derived carbon or CDC. In CDCs produced in this manner, the carbide lattice is used as a template and metal is extracted layer by layer. Thus, a high degree of control at the nanoscale level can be achieved in the synthesis process. The structure of the carbon can be templated by the carbide structure, with the further structural and porosity modification possible by temperature control, environment, and other process variables.

In the method of the present invention high surface area porous carbon or carbon-containing materials useful for storage or adsorption of gases are produced from an inorganic carbon-containing metal precursor by removal of a majority of non-carbon atoms from the inorganic carbon-containing precursors. Inorganic carbon-containing precursors useful in the present invention contain compounds based on metals, metalloids or combinations thereof selected from the group consisting of Ti, Zr, Hf, V, Ta, Nb, Mo, W, Fe, Al, Si, B, Ca and Cr. Preferably the inorganic carbon-containing precursor comprises a carbide, a mixture of carbides or carbonitrides or a mixture of carbides and carbonitrides. The carbon containing precursor may have amorphous, nanocrystalline, microcrystalline, or crystalline structure. Carbon containing precursors useful in the present invention include, but are not limited to, binary and ternary carbides and their mixtures.

The inorganic carbon-containing precursor used in the method of the present invention may comprise a powder with particles ranging in size from 10 nm up to 20,000 nm. Characteristic size or average diameter ranges for the precursor particles are preferably 1,000 to 10,000 nm, more preferably 500-1,000 nm, more preferably 100-500 nm or more preferably 10-100 nm. Small (<500 nm) size of the precursor particles decreases the overall time needed for the production of high surface area carbon-containing material. Small precursor particles also allow faster diffusion of gas in and out of these particles and may advantageously, particularly for applications involving storage and/or adsorption of gases, affect the structure and the properties of the porous carbon produced.

Alternatively, the inorganic carbon containing precursor may be a bulk, e.g. sintered inorganic carbon containing precursor.

In the method of the present invention non-carbon atoms from the inorganic carbon-containing precursor are removed by thermo-chemical, chemical or thermal treatment(s) of the inorganic carbon-containing precursor in the temperature range of 10-1500° C., preferably in the temperature range of 300-1200° C. In a preferred embodiment, high surface area carbon-containing material is produced by halogenation, more preferably chlorination of the precursor in the temperature range of 10-1200° C., more preferably in the temperature range of 300-1000° C., even more preferably in the temperature range of 400-800° C. Low synthesis temperatures are preferred because of their lower cost, and the resulting higher concentration of carbon atoms situated at the edge of graphene fragments, higher reactivity of the synthesized nanocellular carbon the with gases (and/or liquids) when they are used to modify surface chemistry and composition of the produced high surface area carbon, and an often improved performance in gas sorption applications.

In one embodiment of the method of the present invention, initial high surface area carbon samples having high concentration of carbon atoms situated at the edge positions within graphene fragments are produced by halogenation, more preferably chlorination of metal or metalloid containing inorganic carbon-containing precursors at low temperatures below 800° C., more preferably below 600° C.

Following halogenation, the method of the present invention may further comprise treatment with a hydrogen or nitrogen containing gas or gas mixture at an elevated temperature. By treatment with a hydrogen or nitrogen containing gas or gas mixture it is meant to include immersion in a hydrogen or nitrogen containing gas or flowing through of a hydrogen or nitrogen containing gas. In a preferred embodiment, synthesis of the high surface area carbon-containing material involves treatment with a nitrogen containing gas or gas mixture comprising ammonia (NH₃), more preferably ammonia (NH₃) and atomic and/or molecular hydrogen. In this embodiment, synthesis of the high surface area carbon-containing material preferably comprises halogenation of the inorganic carbon-containing precursor followed by treatment in an ammonia containing gas or gas mixture at temperature and gas flow conditions selected so that a substantial (>1%) amount of ammonia decomposes into nitrogen and hydrogen. Further, it is preferred that the treatment in ammonia containing gas or gas mixture be performed on high surface area carbon samples having a high, preferably 1-60%, concentration of carbon atoms situated at the edge positions within graphene fragments.

Alternatively, following halogenation, the method of the present invention may further comprise treatment with another gas or gas mixture for the purpose of functionalization of carbon surface for further enhancement of adoption or gas storage properties.

These post-halogenation treatments result in incorporation of nitrogen or other species in either the carbon structure and/or functional groups bonded to the surface of the carbon material.

Preferably, the post-halogenation treatment in a gas (or gas mixture or solution) is done in-situ, after the halogenation, without exposing samples to air, reactive gas mixture, and/or poorly controlled environment. Additional physical and/or chemical activation techniques may be used to further modify porosity of the produced carbon-containing material. In one embodiment, the gas or gas mixture contains oxygen in its elemental composition, such as, but not limited to, air, H₂O, or CO₂, which acts as an activation agent.

Various CDCs of different pore sizes (0.4 to 1.5 nm) and high specific surface areas (300-2000 m²/g) have been produced using different metal carbides.

Gas storage measurements were performed on nanoporous carbons produced by chlorination of metal carbides at various temperatures (200-1200° C.) with and without hydrogen post treatment. The reactions were performed in a quart tube furnace with a chlorine flow of 20 sccm. Post treatment of the nanoporous carbon produced by chlorination of metal carbide was done with a flow of hydrogen or ammonia at an elevated temperature of 600° C. for 2 hours. Average pore sizes and total pore volumes were calculated from Ar isotherms at −196° C. (Autosorb-1, Quantachrome) using NLDFT (Non Local Density Functional Theory) method. Specific surface area was calculated according to BET (Brunauer, Emmet, and Teller) theory. Hydrogen storage measurements were also performed using the same equipment at −196° C. and up to a pressure of 1 atm. Additionally, high pressure hydrogen storage measurements were performed by VTI, Inc. at room temperature. CO₂ storage measurements were performed using Autosorb-1 (Quantachrome) at about 0° C. and at pressures up to 1 atm.

The amount of chlorine stored in CDC was evaluated using energy dispersive X-ray spectroscopy (EDS). Coefficients of elemental sensitivity were used in calculations of chlorine content. While absolute values of elemental composition can be determined with the accuracy of one percent or less, we believe the EDS studies provided underestimated values due to the exposure of samples to vacuum required for the analysis.

It was found that the CDCs are highly effective materials for gas storage. The pore size distribution and microstructure of CDC may be optimized for adsorption (or storage) of a specific gas (or gas mixture) at the required conditions (temperature, pressure, etc.)

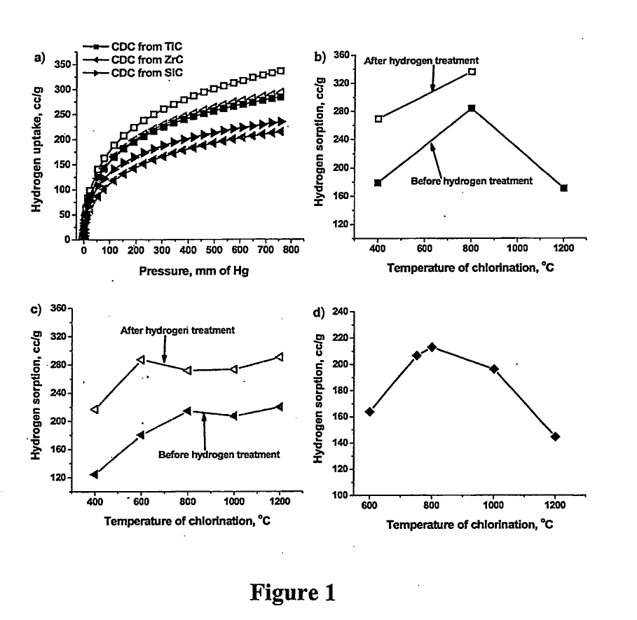

FIGS. 1-7 demonstrate examples of using high surface area porous carbon materials derived from inorganic precursors (such as CDC) for adsorption and storage of various gases at various experimental conditions (various temperatures and pressures).

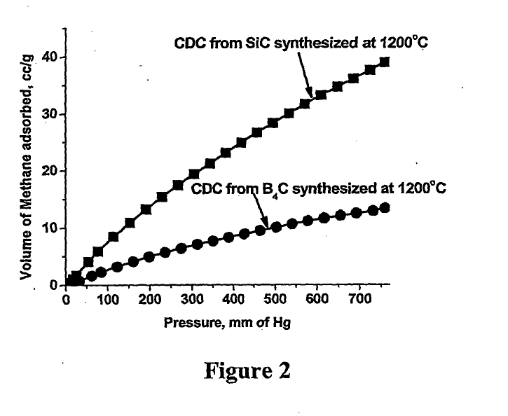

The hydrogen storage at ambient pressure for CDCs not subjected to post treatment varied from 1.4 wt % to 2.8 wt % at liquid nitrogen temperature and methane storage capacity reached 2.8 wt % (40.57 v/v) at room temperature (See FIG. 2).

FIG. 1 shows the effect of hydrogen treatment on hydrogen storage capacity of CDCs. The hydrogen storing capacity increased after post treatment in hydrogen reaching 1.9 wt % to 3.0 wt %.

Further, optimum synthesis temperatures were identified where the storage capacity is maximized. As shown in FIG. 1(b-d), this optimum synthesis temperature varied for different metal carbides.

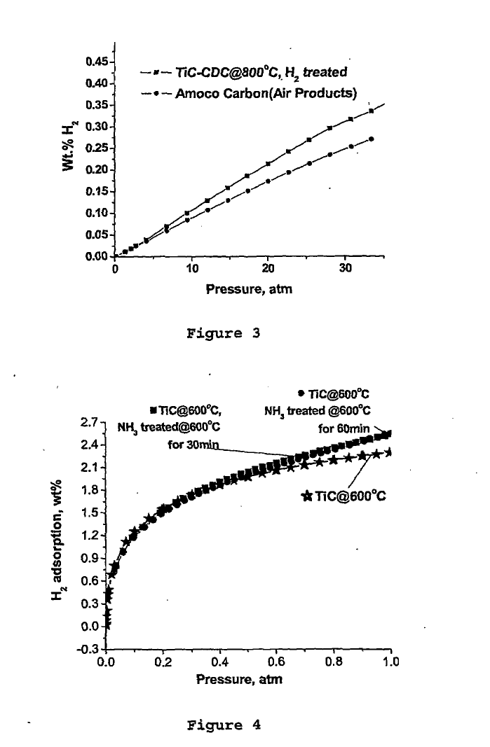

FIG. 3 shows superior hydrogen storage capacity of CDC as compared to advanced activated carbon AX21 (Amoco Carbon) at room temperature and pressures up to 35 atmospheres. AX21 is considered a bench-mark for hydrogen adsorption.

FIG. 5 demonstrates the use of CDC for adsorption of gas containing oxygen and carbon in its elemental composition (in a give case it was CO₂). The CDC with different microstructure and porosity results in different gas sorption capacity. In this example the microstructure and porosity were changed by using different inorganic precursors, namely ZrC and TiC and different synthesis temperatures.

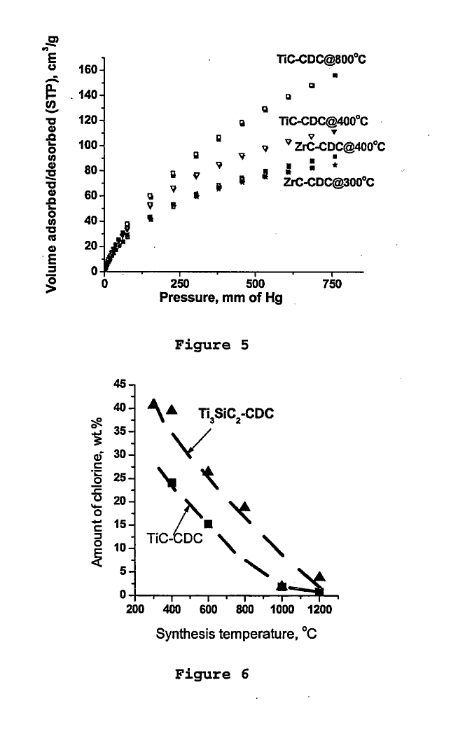

FIG. 6 demonstrates the use of CDC for the storage of a halogen (in a given case it was chlorine). CDC synthesized by chlorination of carbides at moderate temperatures (below 1000 C) was capable to capture huge quantities of the halogen. Lower CDC synthesis temperature resulted in a higher storage capacity.

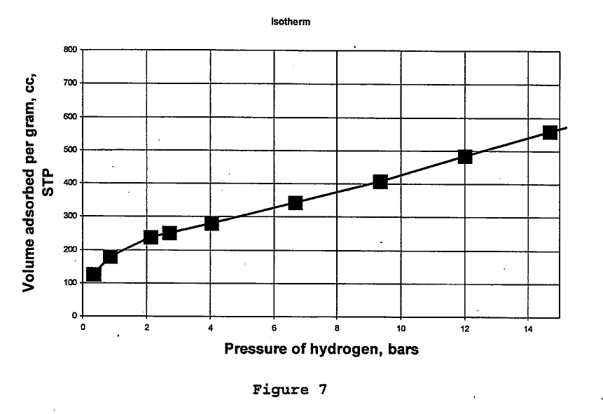

FIG. 7 demonstrates the use of CDC nanoparticles for efficient adsorption of gases. Experiments on hydrogen adsorption were performed by VTI, Inc at 77K and elevated pressures.

The high surface area carbon-containing material produced in accordance with the present invention can be used in applications involving either storage or sorption of gases. For example, the high surface area carbon-containing material can be used as an adsorbent. Absorbent media comprising the high surface area carbon-containing material produced in accordance with the present invention is useful in enhancing gas storage below 1 atmosphere, at 1 atmosphere, or above 1 atmosphere. Further, this absorbent media is useful in enhancing gas storage below room temperature, at room temperature or above room temperatures. The use of high surface area carbon-containing material according to any one of the claims 25-28, where the gas is stored at about the room temperature below 1 atmosphere. Accordingly gas can be stored using this absorbent media below room temperature below atmospheric pressure, at about room temperature above atmospheric pressure, and/or below room temperature above atmospheric pressure.

The high surface area carbon-containing material produced in accordance with the method of the present invention can be used to store the gas or a gas mixture comprising hydrogen, oxygen, and/or carbon in its elemental composition. In a preferred embodiment, the stored gas or gas mixture is H₂, CH₄, or CO₂. Alternatively, the stored gas or gas mixture comprises a halogen such as, but not limited to, F, Cl, Br or I, in its elemental composition. In this embodiment, the stored gas is preferable >50% halogen. When used in this capacity, it is preferred that the high surface area carbon-containing material be produced using the same halogen as being stored. For example, if the CDC is produced by chlorination of carbide precursors, it is preferred that the CDC be used for the storage or adsorption of chlorine-containing gas.

Accordingly, another aspect of the present invention relates to gas adsorbents comprising a high surface area carbon-containing material produced in accordance with the method of the present invention.

Another aspect of the present invention relates to gas storage containers or cylinders filled with a high surface area carbon-containing material produced in accordance with the method of the present invention. The gas storage cylinders also preferably comprise an adsorbed gas of the required composition. Gas adsorbed on the surface of high surface area carbon-containing material in the gas container or cylinder can be released or desorbed by a pressure or partial pressure) gradient. Preferably, the delivery pressure or the pressure at which gas is evacuated and/or removed from the container is lower than the storage pressure or the pressure at which the gas is stored in the container. Alternatively, gas adsorbed on the surface of high surface area carbon-containing material of the container or cylinder is released or desorbed by increasing the temperature of the high surface area carbon-containing material.

1. A method for production of high surface area porous carbon or carbon-containing material for storage or adsorption of gases comprising removal a majority of non-carbon atoms from an inorganic carbon-containing precursor.

2. The method of claim 1, where the inorganic carbon-containing precursor contains compounds based on metals, metalloids or combinations thereof selected from the group consisting of Ti, Zr, Hf, V, Ta, Nb, Mo, W, Fe, Al, Si, B, Ca and Cr.

3. The method of claim 1 where the inorganic carbon-containing precursor comprises a carbide, a mixture of carbides or carbonitrides or a mixture of carbides and carbonitrides.

4. The method of claim 1 wherein the removal of the non-carbon atoms from the inorganic carbon-containing precursor is performed by a thermo-chemical, chemical or thermal treatment of the inorganic carbon-containing precursor in the temperature range of 10-1500° C.

5. The method of claim 4 wherein the thermo-chemical, chemical or thermal treatment comprises halogenation of the inorganic carbon-containing precursor in the temperature range of 10-1200° C.

6. The method of claim 5 wherein the inorganic carbon-containing precursor is reacted with chlorine gas in the temperature range of 400-800° C.

7. The method of claim 1 wherein the inorganic carbon-containing precursor comprises particles with a size range of 10-20,000 nm range.

8. The method of claim 1 further comprising post-halogenation treatment with a gas or gas mixture at an elevated temperature.

9. The method of claim 8 wherein the gas or gas mixture comprises a hydrogen or nitrogen containing gas.

10. The method of claim 9 wherein the nitrogen containing gas or gas mixture comprises ammonia (NH₃).

11. The method of claim 9 wherein the nitrogen containing gas or gas mixture comprises ammonia (NH₃) and atomic or molecular hydrogen.

12. The method of claim 10 wherein treatment in ammonia containing gas or gas mixture is performed on a high surface area carbon sample having a high concentration of carbon atoms situated at edge positions within graphene fragments.

13. The method of claim 8 wherein treatment with the gas or gas mixture functionalizes and further enhances gas storage properties of the high surface area carbon-containing material.

14. The method of claim 1 wherein the inorganic carbon containing precursor comprises bulk inorganic carbon containing precursor.

15. The method of claim 1 further comprising a physical or chemical activating technique which modifies porosity of the produced high surface area carbon-containing material.

16. The method of claim 15 wherein a gas or gas mixture containing oxygen in its elemental composition is used as an activation agent.

17. The use of a high surface area carbon-containing material produced in accordance with claim 1 for storage or sorption of a gas or gas mixture.

18. The use of claim 17 as an adsorbent.

19. The use of claim 17 wherein the gas or gas mixture to be adsorbed or stored comprises hydrogen, oxygen or carbon it its elemental composition.

20. The use of claim 19 where the gas or gas mixture is H₂, CH₄, or CO₂.

21. The use of claim 17 wherein the gas or gas mixture contains a halogen in its elemental composition.

22. The use of claim 21 wherein the gas or gas mixture is greater than 50% halogen.

23. An adsorbent comprising a high surface area carbon-containing material produced in accordance with the method of claim 1.

24. A gas storage cylinder or container comprising a high surface area carbon-containing material produced in accordance with the method of claim 1.

25. A composition comprising a high surface area carbon-containing material produced in accordance with the method of claim 1.
